(19) United States
(12) Patent Application Publication
(10) Pub. No.: US 2026/0340397 A1
(43) Pub. Date: Oct. 29, 2026

(54) SYSTEMS AND METHODS FOR OPTIMIZING PROMPTS IN A GENERATIVE ARTIFICIAL-INTELLIGENCE (AI) MODEL

(71) Applicant: ACCENTURE GLOBAL SOLUTIONS LIMITED, Dublin 4 (IE)

(72) Inventors: Kapil SINGI, Bangalore (IN); Kuntal Dey, Birbhum (IN); Vikrant Kaulgud, Bangalore (IN); Vibhu Saujanya Sharma, Bangalore (IN); Adam Patten Burden, Tampa, FL (US); Manish Ahuja, Gurugram (IN); Niel Eyde, St. Petersburg, FL (US); Alison Detwiler, Harteysville, PA (US)

(73) Assignee: ACCENTURE GLOBAL SOLUTIONS LIMITED, Dublin 4 (IE)

(21) Appl. No.: 19/192,133

(22) Filed: Apr. 28, 2025

(51) Int. Cl. G06N 3/0895

(52) U.S. Cl. CPC G06N 3/0895

(57) ABSTRACT

Systems and methods for optimizing prompts in a generative Artificial-Intelligence (AI) model are disclosed. The system receives an input prompt data from data sources, and determines prompt attributes corresponding to the input prompt data based on tokens. Furthermore, the system generates a sub-prompt for the input prompt data and estimates response tokens for each of the sub-prompt based on a set of parameters. Furthermore, the system generates a contextual dependency matrix between each of the sub-prompt and generate a merged prompt. Further, the system generates a Large Language Model (LLM) response for the merged prompt. Furthermore, the system validates the LLM response to determine whether the LLM response matches the task in the input prompt data using the trained LLM. Further, the system fine tunes the LLM response, the estimated plurality of response tokens and the sub-prompt and outputs the fine-tuned LLM response.

### TECHNICAL FIELD

The present disclosure generally relates to artificial intelligence systems and, more specifically, relates to systems and methods for optimizing prompts in a generative Artificial-Intelligence (AI) model.

### BACKGROUND

Large Language Models (LLMs), such as transformer-based models, may use a neural network architecture to understand and generate natural language-based outputs. In research and enterprise environment, such models are often referred to as foundation models due to their extensive pretraining on large datasets and versatility for various tasks.

Additionally, such models which generate text sequentially are often referred to as autoregressive language models. Another common descriptor in the LLMs may be Pretrained Language Models (PLMs), which emphasize initial training of the models on general data prior to task-specific fine-tuning. Some of the LLMs, may have revolutionized the landscape of Artificial Intelligence by using highly sophisticated natural language processing techniques. Furthermore, such models may rely on tokenization processes to convert human language into numerical representations. However, one of the most common, critical and often overlooked vulnerability in such LLM pipelines may reside in a tokenization layer.

Large Language Models (LLMs) and LLM-based agents process input through tokenization, with performance constrained by a fixed context window defined by the maximum number of tokens the model can handle. The context window encompasses the combined token count of raw input, prompt text, and generated output. A critical challenge arises when this combined token count approaches or exceeds the context window limit, leading to token overflow. Token overflow results in truncation of input, incomplete output, or outright failure, significantly degrading model reliability and performance, particularly in applications requiring high precision.

The issue of token overflow is exacerbated by the dynamic and unpredictable nature of input sizes, where raw input length varies significantly. Current approaches fail to adequately address this problem, as they do not dynamically adjust prompt structures or estimate output token requirements relative to the model's context window capacity. Consequently, these limitations lead to inefficiencies, suboptimal responses, and reduced effectiveness in handling complex or variable-length inputs.

Additionally, tokenization failures in LLMs may include unexpected splitting of words, misinterpretation of symbols, and improper handling of out-of-vocabulary (OOV) tokens. Such tokenization failures may severely impact the quality, consistency, and reliability of model outputs. Furthermore, such issues may be particularly problematic in LLM-powered agents, which may operate in high-stakes and dynamic environments, such as autonomous decision-making systems, customer service bots, and code generation assistants. Despite significant investments in prompt engineering and fine-tuning, some methods may still not adequately address token-level inconsistencies and failures introduced before the model begin inferencing the inputs or input prompts.

Additionally, the LLMs may rely on tokenization to process the inputs and generate responses. However, the interplay between raw input length, prompt structure, and model limitations may often cause such tokenization failures. Further, managing the response context, which may dynamically vary based on a combined token count of raw input, prompt text, and output, may still be a critical challenge. Furthermore, the abovementioned process may often lead to truncation, incomplete outputs, and failures, especially when handling inputs of varying lengths. For instance, when processing unpredictable raw input sizes, the model may exceed token limit, which may result in incomplete and suboptimal responses. Such solutions or processes may not sufficiently refine prompts based on input characteristics and estimate output token requirements relative to capacity of the model, which may lead to inefficiencies and reduced performance in precision-dependent applications. Further, in existing system frequently the output may be incomplete and the existing system may still rely on the context window and the output may fail when the original response overflows the context window even though max token parameter may be very less.

Therefore, there may be a need for an improved systems and methods for optimizing prompts in a generative Artificial-Intelligence (AI) model in order to improve and strengthen robustness of the LLMs and mitigate token overflow failures.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a system for optimizing prompts in a generative Artificial-Intelligence (AI) model. The system receives an input prompt data from a plurality of data sources. Further, the input prompt data comprises at least one task and a plurality of tokens associated with the at least one task. Furthermore, the system determines a plurality of prompt attributes corresponding to the received input prompt data based on the plurality of tokens. Furthermore, the system generates at least one sub-prompt for the received input prompt data based on the determined plurality of prompt attributes. Furthermore, the system estimates a plurality of response tokens for each of the generated at least one sub-prompt based on a set of parameters. Furthermore, the plurality of response tokens corresponds to the plurality of tokens comprised in the input prompt data. Furthermore, the system generates a contextual dependency matrix between each of the generated at least one sub-prompt based on a context and an intent of the generated at least one sub-prompt. Furthermore, the system generates a merged prompt by merging each of the generated at least one sub-prompt based on the estimated plurality of response tokens and the contextual dependency matrix. Furthermore, the system generates a Large Language Model (LLM) response for the merged prompt based on a prompt response order, by applying the generated merged prompt onto a trained Large Language Model (LLM). Furthermore, the system validates the generated LLM response to determine whether the generated LLM response matches the at least one task comprised in the input prompt data using the trained Large Language Model (LLM). Furthermore, the system fine tunes the generated LLM response, the estimated plurality of response tokens and the generated at least one sub-prompt based on results of validation. Furthermore, the system outputs the fine-tuned LLM response, the fine-tuned plurality of response tokens and the fine-tuned at least one sub-prompt on a user interface of a user device.

In another aspect, the present disclosure relates to a method for optimizing prompts in a generative AI model. Further, the method may include receiving, by a processor, an input prompt data from a plurality of data sources. Furthermore, the input prompt data may include at least one task and a plurality of tokens associated with the at least one task. Furthermore, the method may include determining, by the processor, a plurality of prompt attributes corresponding to the received input prompt data based on the plurality of tokens. Furthermore, the method may include generating, by the processor, at least one sub-prompt for the received input prompt data based on the determined plurality of prompt attributes. Furthermore, the method may include estimating, by the processor, a plurality of response tokens for each of the generated at least one sub-prompt based on a set of parameters. Furthermore, the plurality of response tokens may correspond to the plurality of tokens comprised in the input prompt data. Furthermore, the method may include generating, by the processor, a contextual dependency matrix between each of the generated at least one sub-prompt based on a context and an intent of the generated at least one sub-prompt. Furthermore, the method may include generating, by the processor, a merged prompt by merging each of the generated at least one sub-prompt based on the estimated plurality of response tokens and the contextual dependency matrix. Furthermore, the method may include generating, by the processor, a Large Language Model (LLM) response for the merged prompt based on a prompt response order, by applying the generated merged prompt onto a trained Large Language Model (LLM). Furthermore, the method may include validating, by the processor, the generated LLM response to determine whether the generated LLM response matches the at least one task comprised in the input prompt data using the trained Large Language Model (LLM). Furthermore, the method may include fine tuning, by the processor, the generated LLM response, the estimated plurality of response tokens and the generated at least one sub-prompt based on results of validation. Furthermore, the method may include outputting, by the processor, the fine-tuned LLM response, the fine-tuned plurality of response tokens and the fine-tuned at least one sub-prompt on a user interface of a user device.

In yet another aspect, the present disclosure relates to a non-transitory computer readable medium comprising a processor-executable instructions that cause a processor to receive an input prompt data from a plurality of data sources. Further, the input prompt data may include at least one task and a plurality of tokens associated with the at least one task. Furthermore, the processor may determine a plurality of prompt attributes corresponding to the received input prompt data based on the plurality of tokens. Furthermore, the processor may generate at least one sub-prompt for the received input prompt data based on the determined plurality of prompt attributes. Furthermore, the processor may estimate a plurality of response tokens for each of the generated at least one sub-prompt based on a set of parameters. Furthermore, the plurality of response tokens may correspond to the plurality of tokens comprised in the input prompt data. Furthermore, the processor may generate a contextual dependency matrix between each of the generated at least one sub-prompt based on a context and an intent of the generated at least one sub-prompt. Furthermore, the processor may generate a merged prompt by merging each of the generated at least one sub-prompt based on the estimated plurality of response tokens and the contextual dependency matrix. Furthermore, the processor may generate a Large Language Model (LLM) response for the merged prompt based on a prompt response order, by applying the generated merged prompt onto a trained Large Language Model (LLM). Furthermore, the processor may validate the generated LLM response to determine whether the generated LLM response matches the at least one task comprised in the input prompt data using the trained Large Language Model (LLM). Furthermore, the processor may fine tune the generated LLM response, the estimated plurality of response tokens and the generated at least one sub-prompt based on results of validation. Furthermore, the processor may output the fine-tuned LLM response, the fine-tuned plurality of response tokens and the fine-tuned at least one sub-prompt on a user interface of a user device.

To further clarify the features of the present disclosure, a more particular description of the disclosure may follow by reference to specific embodiments thereof, which may be illustrated in the appended figures. One may appreciate that these figures depict typical embodiments of the disclosure and may therefore not to be considered limiting in scope. The disclosure may be described and explained with additional specificity and detail with the appended figures.

### BRIEF DESCRIPTION OF DRAWINGS

The accompanying drawings, which are incorporated herein, and constitute a part of this invention, illustrate exemplary embodiments of the disclosed methods and systems in which like reference numerals refer to the same parts throughout the different drawings. Components in the drawings are not necessarily to scale, emphasis instead being placed upon clearly illustrating the principles of the present invention. Some drawings may indicate the components using block diagrams and may not represent the internal circuitry of each component. It will be appreciated by those skilled in the art that invention of such drawings include the invention of electrical components, electronic components or circuitry commonly used to implement such components.

FIG. 1A illustrates an example block diagram representation of environment for optimizing prompts in a generative Artificial-Intelligence (AI) model, according to an example.

FIG. 1B illustrates an exemplary block diagram representation of a system such as those shown in FIG. 1A, capable of optimizing prompts in a generative Artificial-Intelligence (AI) model, according to an example.

FIG. 2 illustrates an example flow diagram representation depicting steps to optimize prompts at runtime for mitigating Large Language Model (LLM) and LLM based agent failures, according to an example.

FIG. 3 illustrates an example flow diagram representation depicting a response token estimation process, according to an example.

FIG. 4A illustrates an example schematic diagram representation depicting an LLM-based agentic system for optimizing prompts in a generative Artificial-Intelligence (AI) model, according to an example.

FIG. 4B illustrates an example flow diagram representation depicting a Large Language Model (LLM) powered application for optimizing prompts in a generative Artificial-Intelligence (AI) model, according to an example.

FIG. 5 illustrates an example block diagram representation of a hardware platform for implementation of the disclosed system, according to an example.

FIG. 6 illustrates an example flow chart depicting an example method for optimizing prompts in a generative Artificial-Intelligence (AI) model, according to an example.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, and the like. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes”,” “has,” “contains,” and other similar words are used in either the detailed description or the claims, such terms are intended to be inclusive—in a manner similar to the term “comprising” as an open transition word—without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Examples of the present disclosure provides systems and methods for optimizing prompts in a generative Artificial-Intelligence (AI) model. The system receives an input prompt data from a plurality of data sources. Further, the input prompt data comprises at least one task and a plurality of tokens associated with the at least one task. Furthermore, the system determines a plurality of prompt attributes corresponding to the received input prompt data based on the plurality of tokens. Furthermore, the system generates at least one sub-prompt for the received input prompt data based on the determined plurality of prompt attributes. Furthermore, the system estimates a plurality of response tokens for each of the generated at least one sub-prompt based on a set of parameters. Furthermore, the plurality of response tokens corresponds to the plurality of tokens comprised in the input prompt data. Furthermore, the system generates a contextual dependency matrix between each of the generated at least one sub-prompt based on a context and an intent of the generated at least one sub-prompt.

Furthermore, the system generates a merged prompt by merging each of the generated at least one sub-prompt based on the estimated plurality of response tokens and the contextual dependency matrix. Furthermore, the system generates a Large Language Model (LLM) response for the merged prompt based on a prompt response order, by applying the generated merged prompt onto a trained Large Language Model (LLM). Furthermore, the system validates the generated LLM response to determine whether the generated LLM response matches the at least one task comprised in the input prompt data using the trained Large Language Model (LLM). Furthermore, the system fine tunes the generated LLM response, the estimated plurality of response tokens and the generated at least one sub-prompt based on results of validation. Furthermore, the system outputs the fine-tuned LLM response, the fine-tuned plurality of response tokens and the fine-tuned at least one sub-prompt on a user interface of a user device.

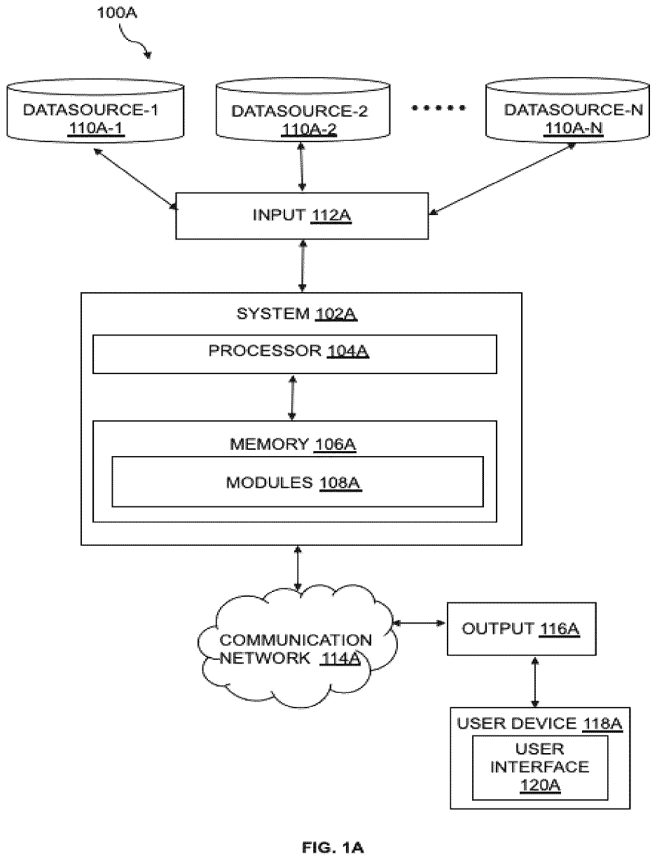

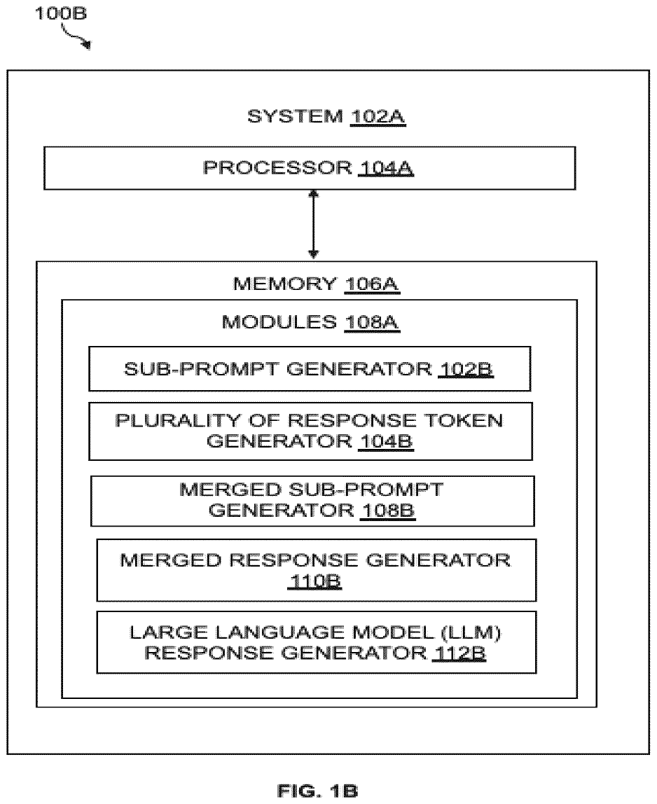

Referring now to the drawings, and more particularly to FIG. 1 through FIG. 6, where similar reference characters denote corresponding features consistently throughout the figures, there are shown preferred embodiments and these embodiments are described in the context of the following exemplary system and/or method.

FIG. 1A illustrates an example block diagram 100A representation of environment for optimizing prompts in a generative Artificial-Intelligence (AI) model, according to an example. Further, the system 102A may receive an input prompt data 112A from a plurality of data sources 110A-1, 110A-2 . . . and 110A-N (individually referred to as the data source 110A, and collectively referred to as the data sources 110A). Furthermore, the input prompt data 112A may include at least one task and a plurality of tokens associated with the at least one task. In an example, the at least one task may be a user requirement, or a desired action to be performed, or may be a sentence (such as for example, a questionnaire or the like). In an example, the plurality of tokens may be multiple discrete units (words, sub words, or symbols) derived from the input prompt data 112A, representing a content to be interpreted. Furthermore, the system 102A may include a processor 104A and a memory 106A operatively coupled with the processor 104A. Furthermore, the memory 106A may include processor-executable instructions in the form of a plurality of modules 108A. Furthermore, the system 102A may be communicatively coupled to a communication network 114A. Furthermore, the communication network 114A may be coupled to an output 116A (also referred herein as output data 116A). Furthermore, the output 116A may be displayed on a user interface 120A of a user device 118A. Furthermore, the system 102A may determine a plurality of prompt attributes corresponding to the received input prompt data 112A based on the plurality of tokens. Furthermore, the system 102A may generate at least one sub-prompt for the received input prompt data based on the determined plurality of prompt attributes. Furthermore, the system 102A may estimate a plurality of response tokens for each of the generated at least one sub-prompt based on a set of parameters. Furthermore, the plurality of response tokens may correspond to the plurality of tokens comprised in the input prompt data 112A. The plurality of response tokens may be multiple predicted tokens that may be generated by the LLM as a response to each sub-prompt. An example is depicted below.

Furthermore, the system 102A may generate a contextual dependency matrix between each of the generated at least one sub-prompt based on a context and an intent of the generated at least one sub-prompt. In an example, the contextual dependency matrix corresponds to a data structure showing how the sub-prompts are contextually linked to one another. Furthermore, the system 102A may generate a merged prompt by merging each of the generated at least one sub-prompt based on the estimated plurality of response tokens and the contextual dependency matrix. Furthermore, the system 102A may generate a Large Language Model (LLM) response for the merged prompt based on a prompt response order, by applying the generated merged prompt onto a trained Large Language Model (LLM). Furthermore, the system 102A may validate the generated LLM response to determine whether the generated LLM response matches the at least one task comprised in the input prompt data 112A using the trained Large Language Model (LLM). Furthermore, the system 102A may fine tune the generated LLM response, the estimated plurality of response tokens and the generated at least one sub-prompt based on results of validation. Furthermore, the system 102A may output 116A the fine-tuned LLM response, the fine-tuned plurality of response tokens and the fine-tuned at least one sub-prompt on the user interface 120A of the user device 118A.

Further, the data source 110A may refer to at least one of a structured and an unstructured content, which the AI may refer and use to generate accurate and relevant responses. Furthermore, the data source 110A may be of different types such as but not limited to data base stored for internal documentation, a web data, file-based sources, custom embedding indexes, and user inputs and real-time context. Furthermore, internal documentation may include but not limited to manuals, Frequently Asked Questions (FAQs), and product guides. Furthermore, the web-data may include but not limited to public websites, forums, blogs, news, and the like. Furthermore, the file-based sources may include but not limited to word documents and internal reports. Furthermore, the custom embedding indexes may include but not limited to vector databases created by chunking and embedding domain-specific content. Furthermore, the user inputs and real-time context may include but not limited to chat history, previous messages, and user profile information.

Further, the user device 118A may be associated with, but not limited to, a user, an individual, an administrator, a vendor, a technician, a worker, a specialist, an instructor, a supervisor, a team, an entity, an organization, a company, a facility, a bot, any other user, and combination thereof. The entities, the organization, and the facility may include, but are not limited to, a hospital, a healthcare facility, an exercise facility, a laboratory facility, an e-commerce company, a merchant organization, an airline company, a hotel booking company, a company, an outlet, a manufacturing unit, an enterprise, an organization, an educational institution, a secured facility, a warehouse facility, a supply chain facility, any other facility and the like. Further, the user device 118A may be used to provide the input 112A and/or receive the output 116A to/from the system 102A. Further, the user device 118A may present to the user one or more user interfaces for the user to interact with the system 102A for optimizing prompts in a generative Artificial-Intelligence (AI) model. Furthermore, the user device 118A may be at least one of, an electrical, an electronic, an electromechanical, and a computing device. Furthermore, the user device 118A may include, but is not limited to, a mobile device, a smartphone, a personal digital assistant (PDA), a tablet computer, a phablet computer, a wearable computing device, a virtual reality/augmented reality (VR/AR) device, a laptop, a desktop, a server, and the like.

Further, the user interface 120A may include but not limited to a prompt builder interface, a drag-and-drop prompt designer, a prompt templates gallery, an inline assist with tooltips, and a form-based prompt user interface (UI). Furthermore, the prompt builder interface may utilize at least one of a no-code and a low-code tools, which may allow users to create AI prompts without writing raw text. Furthermore, the drag-and-drop prompt designer may utilize visual flow for building multi-step prompt logic, which may be common in chatbots and workflows. Furthermore, in the prompt templates gallery, users select pre-made prompt patterns and customize pre-made prompt patterns. Furthermore, an inline assist with tooltips may include assisted prompting with guidance next to each field. Furthermore, the form-based prompt UI may collect structured inputs to plug into a dynamic prompt template.

Further, the system 102A may be implemented by way of a single device or a combination of multiple devices that may be operatively connected or networked together. The system 102A may be implemented in hardware or a suitable combination of hardware and software. Further, the system 102A may include one or more processor(s) 104A, and the memory 106A. The memory 106A may include the plurality of modules 108A. The system 102A may be a hardware device including the processor 104A executing machine-readable program instructions for optimizing prompts in a generative Artificial-Intelligence (AI) model. Execution of the machine-readable program instructions by the processor 104A may enable the system 102A to perform for optimizing prompts in a generative Artificial-Intelligence (AI) model. The “hardware” may comprise a combination of discrete components, an integrated circuit, an application-specific integrated circuit, a field-programmable gate array, a digital signal processor, or other suitable hardware. The “software” may comprise one or more objects, agents, threads, lines of code, subroutines, separate software applications, two or more lines of code, or other suitable software structures operating in one or more software applications or on one or more processors.

The one or more processors 104A may include, for example, microprocessors, microcomputers, microcontrollers, digital signal processors, central processing units, state machines, logic circuits, and/or any devices that manipulate data or signals based on operational instructions. Among other capabilities, the processor 104A may fetch and execute computer-readable instructions in the memory 106A operationally coupled with the system 102A for performing tasks such as data processing, input/output processing, and/or any other functions. Any reference to a task in the present disclosure may refer to an operation being or that may be performed on data.

FIG. 1B illustrates an exemplary block diagram 100B representation of the system 102A such as those shown in FIG. 1A, capable of optimizing prompts in a generative Artificial-Intelligence (AI) model, according to an example. Further, the system 102A may include a processor 104A and the memory 106A operatively coupled with the processor 104A. Furthermore, the memory 106A may include processor-executable instructions in the form of the plurality of modules 108A. Furthermore, the processor 104A may execute the plurality of modules 108A to perform a plurality of steps described below. Furthermore, the plurality of modules 108A may include but not limited to a sub-prompt generator 102B, a plurality of response token generator 104B, a merged sub-prompt generator 108B, a merged response generator 110B, and a Large Language Model (LLM) response generator 112B. Furthermore, execution of the machine-readable program instructions by the processor 104A may enable the system 102A to perform one or more functions. Furthermore, the “hardware” may comprise a combination of discrete components, an integrated circuit, an application-specific integrated circuit, a field programmable gate array, a digital signal processor, or other suitable hardware. Furthermore, the “software” may comprise one or more objects, agents, threads, lines of code, subroutines, separate software applications, two or more lines of code or other suitable software structures operating in one or more software applications or on one or more processors. Furthermore, the processor 104A may include, for example, microprocessors, microcomputers, microcontrollers, digital signal processors, central processing units, state machines, logic circuits, and/or any devices that manipulate data or signals based on operational instructions. Furthermore, among other capabilities, the processor 104A may fetch and execute computer-readable instructions from the memory 106A operationally coupled with the system 102A for performing tasks such as data processing, input/output processing, attributes extraction, and/or any other functions. Any reference to a task in the present disclosure may refer to an operation being, or that may be, performed on data or input information.

In an example, the plurality of prompt attributes may include a context, an intent, a topic modelling, a task type, complexity, dependencies, and sentence segments. The context defines the situational or thematic background of the prompt, such as a legal document analysis or customer service dialogue. The intent specifies the purpose of the prompt, for example, summarizing a text or answering a factual query. The topic modeling identifies key themes or subjects within the input, such as extracting financial trends from a report. The task type categorizes the nature of the task, such as classification, generation, or translation. The complexity, which indicates the level of intricacy required, for instance, solving a multi-step mathematical problem versus generating a simple greeting. The dependencies account for relationships between prompts or inputs, such as sequential prompts in a multi-turn conversation. The sentence segments, which break down the prompt into manageable syntactic units, such as individual clauses in a complex query. Further, the set of parameters may include a Large Language Model (LLM), a tokenizer process, a temperature setting, a prompt embedding, an input embedding, a number of prompts and input tokens. The Large Language Model (LLM) may refer to a specific model architecture employed, such as, for example, but not limited to, a transformer-based model such as GPT or BERT. The tokenizer process defines the method used to convert raw text into tokens, for example, but not limited to, Byte-Pair Encoding (BPE) or Word Piece tokenization. The temperature setting controls the randomness of the model's output, where a low temperature (for example, 0.2) produces deterministic responses, and an elevated temperature (for example, 1.0) increases creativity. The prompt embedding represents the prompt as a numerical vector in the model's latent space, capturing its semantic meaning. The input embedding, similarly, encodes the raw input data into a vector format for processing. The number of prompts quantifies the total prompts provided in a single interaction, such as multiple questions in a batch. The input tokens denote the total count of tokens in the input, for instance, 500 tokens for a lengthy paragraph.

In an example, the processor 104A may generate the at least one sub-prompt for the received input prompt data 112A based on the determined plurality of prompt attributes. Further, the processor 104A may segment the received input prompt data 104A into a plurality of segments based on a syntactic structure, a semantic meaning, and a topic relevance of the received input prompt data using sentence segmentation model. Furthermore, the processor 104A may group the plurality of segments into thematic clusters by detecting similarities in a content, a structure, and the topic between the plurality of segments. Furthermore, the processor 104A may determine a plurality of relationships between the plurality of segments by analyzing dependencies within the received input prompt data. Furthermore, the dependencies may indicate cases where a response to one sub-prompt depends on a response to another sub-prompt. Furthermore, the processor 104A may generate the at least one sub-prompt for the received input prompt data based on the determined plurality of relationships.

In an example, the processor 104A may adjust the at least one sub-prompt based on at least one of feedback received from the trained Large Language Model (LLM), the dependencies, and the context. Further, the processor 104A may validate the at least one sub-prompt for completeness, structural consistency, and alignment with the received input prompt data 112A. Furthermore, the processor 104A may refine the at least one sub-prompt by performing at least one of restructuring, merging, and splitting the sub-prompt based on results of validation.

In an example, the processor 104A may estimate the plurality of response tokens for each of the generated at least one sub-prompt based on the set of parameters. Further, the process may receive a prompt and an input as textual data to be processed from the data sources 110A. Furthermore, the prompt and the input may correspond to the received input prompt data 112A. Furthermore, the processor 104A may generate a tokenized prompt and a tokenized input by tokenizing the received prompt and the input using a tokenizer model. Furthermore, tokenizer model may include a predefined vocabulary and model-specific tokenization rules. Furthermore, the processor 104A may determine a number of prompt tokens and input tokens from the tokenized prompt and the tokenized input. Furthermore, the processor 104A may generate a plurality of embeddings for the prompt and the input based on the determined number of prompt tokens and the input tokens. Furthermore, the plurality of embeddings may include a prompt embedding and an input embedding. Furthermore, the processor 104A may extract a set of model-specific parameters from the trained LLM model. Furthermore, the set of model-specific parameters comprise a type of the LLM, a tokenization method, a temperature setting, and a response generation behavior. Furthermore, the processor 104A may estimate the plurality of response tokens for each of the generated at least one sub-prompt by applying the extracted set of model-specific parameters, the plurality of embeddings, the determined number of prompt tokens and the input tokens as input to an estimator function model. The estimator function model may be a computational process to predict or estimate specific properties of an LLM's behavior, such as token consumption, output length, or processing requirements, based on input characteristics and prompt configurations. This model analyzes factors such as input token count, prompt attributes, and model parameters to forecast potential outcomes, enabling proactive adjustments to prevent issues such as token overflow. For example, an estimator function model might predict that a given input of 1,000 tokens, combined with a complex prompt requiring multi-step reasoning, will produce an output of approximately 300 tokens. By comparing this estimate to the model's context window limit (for example, 2,048 tokens), the system may dynamically truncate or rephrase the prompt to avoid exceeding the limit, thereby enhancing the reliability and efficiency of the LLM's response generation process.

In an example, the processor 104A may generate the plurality of embeddings for the prompt and the input based on the determined number of prompt tokens and the input tokens. Further, the processor 104A may encode a plurality of features associated with the prompt and the input based on the tokenized prompt and the tokenized input. Furthermore, the plurality of features may include an average word length, a number of specific words, and a syntactic complexity. Furthermore, the processor 104A may generate the prompt embedding and the input embedding based on the encoded plurality of features.

In an example, the processor 104A may generate the merged prompt by merging each of the generated at least one sub-prompt based on the estimated plurality of response tokens and the contextual dependency matrix. Further, the processor 104A may estimate a plurality of response token lengths corresponding to each of the sub-prompts using a response token estimator model, and the contextual dependency matrix. Furthermore, the processor 104A may determine a merging strategy for the sub-prompts based on a shared context across the sub-prompts, an overlapping content within the sub-prompts, and dependency relationships indicated in the contextual dependency matrix. Furthermore, the processor 104A may identify at least one dependent sub-prompt where a response to the at least one dependent sub-prompt depends on a response to another sub-prompt. Furthermore, the processor 104A may predict a total plurality of response tokens required for merging the at least one dependent sub prompt. Furthermore, the processor 104A may determine whether the predicted total plurality of response tokens exceeds a context window value. Furthermore, the processor 104A may assign a preference score to the at least one dependent sub prompt based on a dependency order. Furthermore, the preference score determines a sequence in which the at least one dependent sub-prompt is to be merged and processed. Furthermore, the processor 104A may merge the at least one dependent sub-prompt based on the merging strategy and until the predicted total plurality of response tokens reach the context window value.

In an example, the processor 104A may generate the Large Language Model (LLM) response for the merged prompt based on the prompt response order. Further, the processor 104A may generate a plurality of partial responses for each of the generated at least one sub-prompt. Furthermore, the processor 104A may process each of the generated plurality of partial responses using a preprocessing model. Furthermore, the processor 104A may determine the prompt response order for generating a final Large Language Model (LLM) response. Furthermore, the processor 104A may generate the final Large Language Model (LLM) response based on the determined prompt response order.

In an example, the processor 104A may validate the generated LLM response to determine whether the generated LLM response matches the at least one task comprised in the input prompt data 112A using the trained Large Language Model (LLM). Furthermore, the processor 104A may extract task-related attributes from the input prompt data 112A. Furthermore, the task-related attributes comprise one a task type, an expected output structure, required information components, and dependencies between a plurality of response components. Furthermore, the processor 104A may generate response embeddings by tokenizing the generated LLM response and encoding the LLM response into an embedding representation using the trained Large Language Model (LLM). Furthermore, the processor 104A may compare the generated response embeddings with expected response embeddings. Furthermore, the expected response embeddings may be derived from predefined task-specific reference embeddings, task type classification models, and historical prompt-response pairs. Furthermore, the processor 104A may determine a response completeness value by determining whether the required information components from the input prompt data 112A are present in the generated LLM response. Furthermore, the processor may detect at least one inconsistency in the generated LLM response by identifying deviations within the generated LLM response, comparing the generated LLM response with pre-stored responses retrieved from external sources, and a response coherence level. Furthermore, the processor 104A may evaluate an accuracy level of dependencies within the generated LLM response by verifying whether referenced sub-responses align with prior context of the merged sub-prompt. Furthermore, the processor 104A may generate a validation score for the generated LLM response based on the determined response completeness value, detected at least one inconsistency, the response coherence level, and the accuracy level of dependencies. For example, if the validation score is above the threshold, the generated response is considered valid, and if the validation score is below the threshold, the response is flagged for refinement or regeneration.

Though few components and subsystems are disclosed in FIGS. 1A-1B, there may be additional components and subsystems which is not shown, such as, but not limited to, ports, network devices, databases, network attached storage devices, assets, machinery, instruments, facility equipment, emergency management devices, image capturing devices, cooling devices, heating devices, compressors, any other devices, and combination thereof. The person skilled in the art should not be limiting the components/subsystems shown in FIG. 1A.

Those of ordinary skilled in the art will appreciate that the hardware depicted in FIGS. 1A-1B may vary for particular implementations. For example, other peripheral devices such as an optical disk drive and the like, local area network (LAN), wide area network (WAN), wireless (for example, wireless-fidelity (Wi-Fi)) adapter, Bluetooth adapter, graphics adapter, disk controller, input/output (I/O) adapter also may be used in addition or place of the hardware depicted. The depicted example is provided for explanation only and is not meant to imply architectural limitations concerning the present disclosure.

Those skilled in the art will recognize that, for simplicity and clarity, the full structure and operation of all data processing systems suitable for use with the present disclosure are not being depicted or described herein. Instead, only so much of the system 102A as is unique to the present disclosure or necessary for an understanding of the present disclosure is depicted and described. The remainder of the construction and operation of the system 102A may conform to any of the various current implementations and practices that were known in the art.

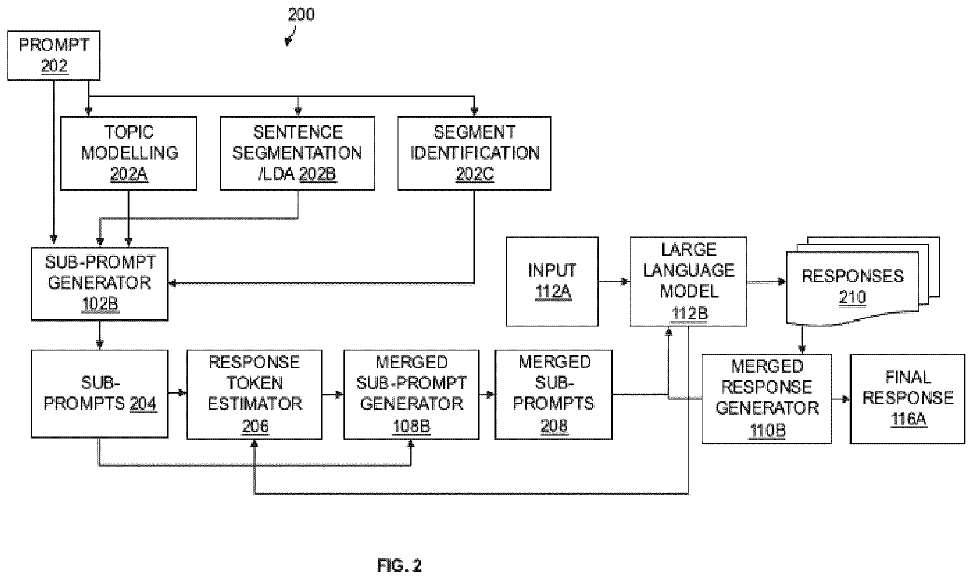

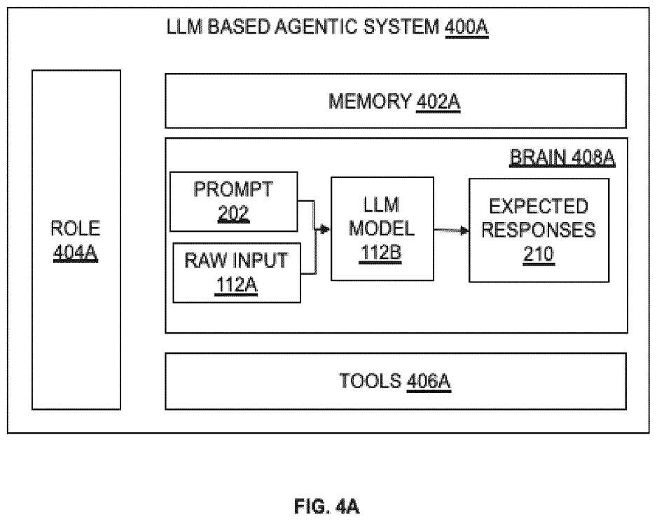

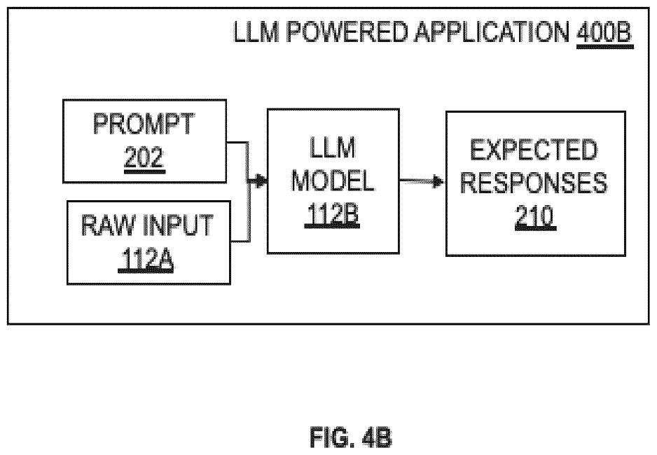

FIG. 2 illustrates an example flow diagram 200 representation depicting steps to optimize a prompt 202 at runtime for mitigating the Large Language Model (LLM) response generator 112B (interchangeably referred to as a Large Language Model (LLM) 112B) and an LLM based agent failures, according to an example. Furthermore, the prompt 202 may include but not limited to a topic modelling 202A, a sentence segmentation 202B (interchangeably referred to as a Latent Dirichlet Allocation (LDA)), and a segment identification 202C. Furthermore, the prompt 202 including but not limited to the topic modelling 202A, the sentence segmentation 202B (interchangeably referred to as a Latent Dirichlet Allocation (LDA), and the segment identification 202C may be fed into the sub-prompt generator 102B. Furthermore, the sub-prompt generator 102B may generate a plurality of sub-prompts 204. Furthermore, the system 102A may mitigate failure in at least one of the LLM 112B and an agentic system, which may utilize the LLM 112B as the core of the system 102A, which may arise due to large response size issues, which may not fit in a context window. Furthermore, the response token estimator 206 may estimate the response token length based on at least one of input, prompt, tokenizer, and model. Furthermore, when total tokens may include input, response and prompt tokens as mentioned in equation 1 mentioned in explanation of FIGS. 4A and 4B may exceed the context window, then the merged sub-prompt generator 108B may deconstruct the prompt into a plurality of merged sub-prompts 208. Further, the plurality of merged sub-prompts 208 may include at least one of a consistent and a cohesive sub-prompt in a way that the responses for each of the plurality of merged sub-prompts 208 may fit in the context window. Furthermore, the LLM 112B may be used to generate a plurality of responses 210 for each of the plurality of merged sub-prompts 208 received in the form of the input prompt data 112A. Furthermore, the merged response generator 110B may in successive iterations merge the plurality of responses 210 to generate a final response 116A.

In an example, the system 102A may use max tokens parameter provided by the LLM 112B to respond in less than a certain number of tokens. However, the system 102A may truncate the output 116A. Furthermore, the system 102A may create the plurality of sub-prompts 204 based on the prompt attributes. Furthermore, the prompt attributes may be identified using but not limited to sentence segmentation, segment identification and topic modelling. Furthermore, as soon as different segments, intent, and topic may be identified, the system 102A may utilize a light-weight language model 212. Furthermore, the light-weight language model 212 may generate the plurality of sub-prompts 204 for different prompt segments. Furthermore, the plurality of sub-prompt may utilize relevant context from prompt which may not be directly present in the different prompt segments.

In an example, the response token estimator 206 may estimate the number of a plurality of response tokens for each of the plurality of sub-prompts 204. Further, a light weight LLM 212 may be used to merge the plurality of sub-prompts 204 into a minimal set of sub-prompts such that the plurality of responses 210 for each of the plurality of sub-prompts 204 along with the input 112A may still fit in the context window. Furthermore, identification of a subset of the plurality of sub-prompts 202 to be merged may be accomplished by using a simple greedy approach to merge the plurality of sub-prompts 204 till length of the context window length may not be reached. Furthermore, the plurality of merged sub-prompts 208 along with the input 112A may be then fed to the LLM 112B to generate the plurality of responses 210 for each of the plurality of sub-prompts 204. Furthermore, the response token lengths the plurality of responses 210 may be used by the response token estimator 206 in order to update learnings of the response token estimator 206. Furthermore, the plurality of responses 210 may be then merged using the light weight language model 212. Furthermore, the light weight language model 212 may merge the plurality of responses 210 while maintaining completeness and consistency of the output 116A (interchangeably referred to as a final response).

In an example, the sub-prompt generator 102B may be the light weight language model 212, which may generate at least one of the consistent and cohesive sub-prompts based on the prompt 202. Further, the sub-prompt generator 102B may work on the prompt 202 including but not limited to the topic modelling 202A, the sentence segmentation 202B, and the segment identification 202C. Furthermore, the sub-prompt generator 102B may use techniques such as but not limited to Latent Dirichlet Allocation (LDA) to group related parts of the prompt 202 into a plurality of thematic clusters. Furthermore, the sub-prompt generator 102B may do a dependency analysis in cases where responses for one sub-prompt may depend on a response to another sub-prompt. Furthermore, the sub-prompt generator 102B may also analyze for cross dependencies. Furthermore, the sub-prompt generator 102B may generate a contextual dependency mapping. Furthermore, in an instance, if the prompt 202 may ask to explain some methods and then provide comparative analysis for all of them. Furthermore, the sub-prompt generator 102B may add a common context to the plurality of sub-prompts 204, which may be missing in various prompt segments such that the plurality sub-prompts 204 may remain self-contained and consistent. Furthermore, the sub-prompt generator 102B may identify at least one of a shared contexts and overlap in scope and thereby adjust the plurality of sub-prompts 204 accordingly. Furthermore, the sub-prompt generator 102B may also validate and refine the plurality of sub-prompts 204. Furthermore, the plurality of sub-prompts 204 may be self-contained, which may cover required tasks. Furthermore, the plurality of sub-prompts 204 may not excessively repeat the context. Furthermore, the merged sub-prompt generator 108B may take the plurality of sub-prompts 204. Furthermore, the merged sub-prompt generator 108B may estimate response token length from the response token estimator 206 and contextual dependency mapping from the sub-prompt generator 102B.

In an example, the merged sub-prompt generator 108B may try to merge the plurality of sub-prompts 204 such that the total estimated response size of the plurality of merged sub-prompts 208 may not overflow the remaining context window. Further, the merged sub-prompt generator 108B while merging the plurality of sub-prompts may at least one of handle shared context, overlap in scope and adjust the plurality of sub-prompts 204 to merge accordingly. Furthermore, the merged sub-prompt generator 108B may give preference to merge dependent sub-prompts based on the dependency mapping received from the sub-prompt generator 102B. Furthermore, the merged sub-prompt generator 108B while merging may not exceed the remaining context of the total estimated response token. Furthermore, when the estimated response may exceed the remaining context for the dependent sub-prompts, which may mean for the prompt 202 where response of one sub-prompt may be required to generate response for another sub-prompt. Furthermore, the merged sub-prompt generator 108B may provide a preference score to different sub-prompt based on an order in which a response may have to be generated. Furthermore, the merged response generator 110B may summarize the response based on a dependent sub-prompt. Furthermore, the merged response generator 110B may feed the response as context to the LLM 112B for generating response for the dependent sub-prompt. Furthermore, the merged response generator 110B may be also the light weight language model 212, which may be responsible for combining partial responses into at least one of a coherent and a cohesive final response. Furthermore, the merged response generator 110B may ensure the merging may be smooth for example, while combining a background info response with a related specific query response. Furthermore, the merged response generator 110B may refine a merged response to eliminate including but not limited to redundancies, inconsistencies, and gaps in logic.

In an example, the response token estimator 206 may estimate response tokens for particular tasks given by input tokens. Furthermore, an estimation of response tokens may be achieved by collecting at least one of the input tokens, a corresponding response token data and learning an estimator function. Furthermore, the estimator function may include but not limited to linear regressor, Support Vector Machine (SVM), decision tree, and neural network. Furthermore, the response tokens may depend on including but not limited to task type, LLM model, tokenizer, temperature, prompt embedding, input embedding, number of prompt and input tokens, for example, in summarization tasks. Furthermore, the response tokens may be 10% to 20% of input tokens, while the queries and code generations tasks may generate 10× response tokens with respect to the input tokens. Furthermore, the response tokens may also depend on the LLM 112B, for example, the openAI models may tend to not to generate very large responses. Furthermore, for code generation tasks, complexity of the prompt 202 may influences number of the response tokens. Furthermore, for simpler queries, the response tokens may be many times of the input tokens whereas for larger specific queries, the response tokens may be comparatively shorter with respect to the input tokens.

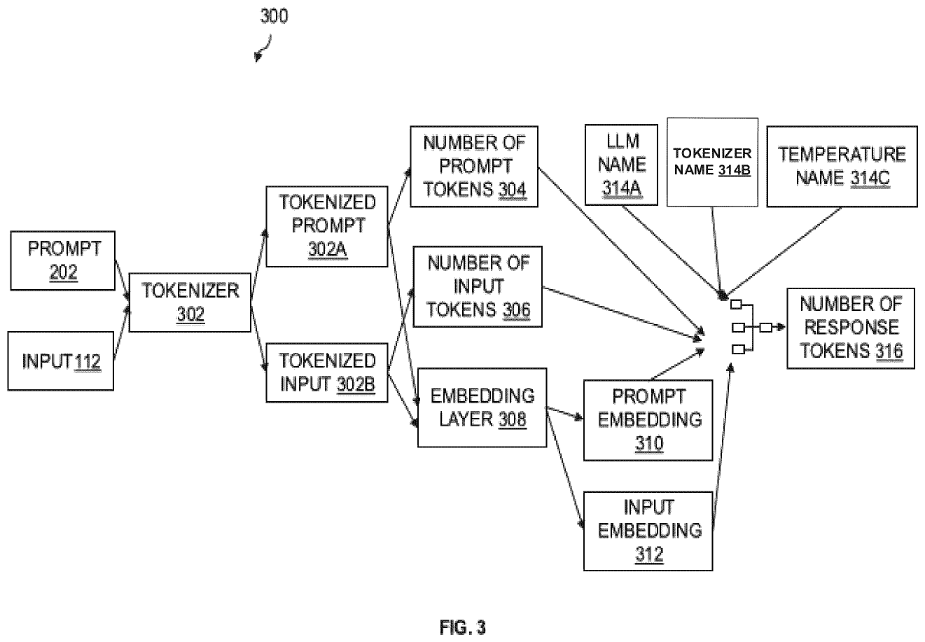

FIG. 3 illustrates an example flow diagram 300 representation depicting a response token estimation process, according to an example. In an example, the response token estimation may be provided. Furthermore, the prompt 202 and the input 112A embedding may be utilized to identify including but not limited to a task type, the prompt 202 and the input 112A complexity by for example encoding features such as but not limited to average word length and number of unique words. Furthermore, the embedding may be at least one of pretrained and learned specifically for the response token estimation task, such as but not limited to updating embeddings while learning token estimation function. Furthermore, the prompt 202 and the input 112A may be fed into a tokenizer 302. Furthermore, the tokenizer 302 may then process the prompt 202 and the input 112A into a tokenized prompt 302A and a tokenized input 302B. Furthermore, the tokenized prompt 302A may include number of prompt tokens 304 and an embedding layer 308. Furthermore, the tokenized input 302B may include number of input tokens 306 and the embedding layer 308. Furthermore, the embedding layer 308 may include a prompt embedding 310 and an input embedding 312. Furthermore, the prompt embedding 310, the input embedding 312, number of prompt tokens 304 and the number of input tokens 306 may then be fed into an estimator function 314. Furthermore, the estimator function may include a Large Language Model (LLM) name 314A, a tokenizer name 314B and a temperature 314C. Furthermore, the estimator function may provide a number of response tokens 316. Furthermore, the tokenizer 302 may be a typical tokenizer model used for tokenizing the prompts and input by the LLM, such as, for example, but not limited to, a BPE (byte pair encoding) and the like. Furthermore, the embedding layer 308 may be a learnable or pretrained layer such as, for example, but not limited to, word2vec, GloVe, BERT, ADA or the like which may be used to generate dense embeddings from text. The Function approximator may be any function approximator such as, for example, but not limited to, neural networks, decision trees, SVM and the like used to map the features to system required output i.e. number of response tokens. First, the tokenizer model tokenizes the input and prompt, which may be used to calculate the number of prompt and input tokens. The embedding layer 308 (pretrained or learnable) then takes the tokenized prompt and input to generate prompt and input embeddings. The prompt and input embeddings are then passed along with number of prompt and input tokens, LLM name, tokenizer model, temperature settings and the like to function approximator to predict the number of response tokens.

In an example, when the input 112A may contain 1,500 tokens. Further, a detailed excerpt may include a timeline of climate-related events, such as but not limited to the industrial revolution, formation of the Intergovernmental Panel on Climate Change (IPCC), Kyoto Protocol, Paris Agreement, and recent carbon emission trends. Furthermore, technological breakthroughs such as but not limited to the invention of solar panels, electric vehicles, wind turbines, and carbon capture technologies. Furthermore, data-driven projections of climate change may impact on the economy, health, and ecosystems. Furthermore, when the prompt 202 may contain 450 tokens. Furthermore, the prompt 202 may ask using the provided dataset on climate change, write a detailed report that may describe historical evolution of global climate policies, explaining how these milestones shaped the international response to climate change. Furthermore, the prompt 202 may ask analyze the role of technological advancements in addressing climate challenges, highlighting key innovations and impact of the same. Furthermore, the prompt 202 may ask for crafting of a forward-looking section outlining actionable strategies for achieving net-zero emissions by 2050. Furthermore, the question of the prompt 202 may make sure such strategies may be informed by both the historical evolution and the technological advancements discussed earlier.

In an example, the sub-prompt generator 102B may be provided. Further, the estimated response length may include approximately 3500 tokens, the context window size may include 4096 tokens, the remaining context size for response may include subtracting 1500 plus 450 from 4096, which may approximately be equivalent to 2100 tokens, the total context used may include 3500 plus1500 input tokens and 450 prompt tokens, which may be equivalent to approximately 5500 tokens, which may be greater than the context window size. Furthermore, the sub-prompt 1 may be provided. Furthermore, the sub-prompt 1 may extract and summarize historical evolution of climate policies, focusing on key milestones such as industrial revolution, IPCC, Kyoto Protocol, and Paris Agreement. Further, the sub-prompt 2 may be provided. Furthermore, the sub-prompt 2 may analyze key technological advancements in climate mitigation such as solar panels, wind turbines, electric vehicles, carbon capture. Furthermore, the sub-prompt 3 may be provided. Furthermore, the sub-prompt 3 may explain significance and impact of key advancements in climate mitigation. Furthermore, the sub-prompt 4 may be included. Furthermore, the sub-prompt 4 may develop a forward-looking strategy for achieving net-zero emissions by 2050. Furthermore, sub-prompt 4 may use insights from both history and technology sections to craft actionable recommendations. Furthermore, dependency may be provided. Furthermore, the dependency may provide that the sub-prompt 4 may depend on outputs from sub-prompts 1, 2 and 3. Furthermore, sub-prompt 3 may depend on response from sub-prompt 2.

In an example, the merged sub-prompt generator 108B may be provided. Further, the estimated response length may include sub-prompt 1 with approximately 1000 tokens, sub-prompt 2 with approximately 1000 tokens, sub-prompt 3 with approximately 500 tokens, and sub-prompt 4 with approximately 1500 tokens. Furthermore, the merged sub-prompt generator 108B may merge the sub-prompt 1, 2 and 3 till remaining context window of approximately 2100 tokens may not breached, thereby giving preference to merging dependent sub-prompts first. Furthermore, the dependencies may provide that sub-prompt 4 may depend on outputs from sub-prompts 1, 2 and 3. Furthermore, sub-prompt 3 may depend on response from sub-prompt 2.

Additionally, the system 102A may merge, the sub-prompts 2 and 3 into a single sub-prompt. Further, the merged set of sub-prompts now may be termed as sub-prompt 1. The sub-prompt 1 may extract and summarize the historical evolution of climate policies, focusing on key milestones such as industrial revolution, IPCC, Kyoto Protocol, and Paris Agreement. The sub-prompt 2 may analyze key technological advancements in climate mitigation such as but not limited to solar panels, wind turbines, electric vehicles, carbon capture, explaining their significance and impact. Furthermore, the sub-prompt 3 may develop a forward-looking strategy for achieving net-zero emissions by 2050. Furthermore, the sub-prompt 3 may use insights from both history and technology sections to craft actionable recommendations. Furthermore, dependency may provide that the sub-prompt 3 may depend on outputs from the sub-prompt 1 and the sub-prompt 2.

In an example, the system 102A may generate responses for each of the sub-prompts using the Large Language Model (LLM) 112B. Further, the responses for the sub-prompt 1 and the sub-prompt 2 may be sent as context for generating the response for the sub-prompt 3 because of dependency mapping. Furthermore, finally, the merged response generator 110B may combines the individual responses into a final coherent and a cohesive response.

In an example, the system 102A may include the input 112A containing approximately around 2000 tokens. Further, the system 102A may include but not limited to Common Business Oriented Language (COBOL) programs and a set of copybook files. Furthermore, the prompt 202 may contain approximately 450 tokens. Furthermore, the prompt 202 may analyze a provided mainframe codebase snippet and summarize the key components by giving overview of the COBOL programs, including purpose, main logic, input handling, validation and output of such COBOL programs. Furthermore, a description of the copybook and how the copybook may be used within the COBOL program may be provided. Furthermore, an analysis of how the Copybook output, and COBOL script may be interconnected within the codebase may be provided. Furthermore, description of interactions of the Copybook output, and a Common Business Oriented Language (COBOL) script may be provided. Furthermore, provide suggestions for improving modularity, maintainability, and performance of the codebase. Furthermore, the sub-prompt 1 may summarize the purpose and functionality of the provided COBOL program. Furthermore, sub-prompt 1 may describe the main logic including input handling, validation, and output generation. Furthermore, the sub-prompt 2 may describe structure and purpose of the Copybook. Furthermore, the sub-prompt may explain how the sub-prompt 2 may be used in the Common Business Oriented Language (COBOL) program. Furthermore, the sub-prompt 3 may analyze how the Copybook output, and COBOL script may be interconnected within the codebase. Furthermore, the sub-prompt 3 may describe interactions between the Copybook output, and the COBOL script. Furthermore, the sub-prompt 4 may provide suggestions for improving the modularity, maintainability, and performance of the codebase. Furthermore, factors like reusable copybook structures, repeated code to be used as paragraph may be considered. Furthermore, the dependency of sub-prompt 4 may be provided. Furthermore, the dependency may provide that the sub-prompt 4 may depend on outputs from the sub-prompt 1, the sub-prompt 2 and the sub-prompt 3. Furthermore, the sub-prompt 3 may depend on response from the sub-prompt 2 and the sub-prompt 1. Furthermore, an estimated response length may include the sub-prompt 1 with approximately 1000 tokens, the sub-prompt 2 with approximately 1000 tokens, the sub-prompt 3 with 500 tokens, and the sub-prompt 4 with 1500 tokens. Furthermore, the merged sub-prompt generator 108B may merge the sub-prompt 1, the sub-prompt 2, the sub-prompt 3 and the sub-prompt 4 till the remaining context window of approximately 2100 tokens may not be breached, giving preference to merging dependent sub-prompts first. Furthermore, using the dependencies, the sub-prompt 4 may depend on outputs from the sub-prompt 1, the sub-prompt 2 and the sub-prompt 3. Furthermore, the sub-prompt 3 may depend on response from the sub-prompt 2 and the sub-prompt 1. Furthermore, the system 102A may not merge, the sub-prompt 1, the sub-prompt 2 and the sub-prompt 3 into a single-sub-prompts as the estimated response token may exceeds remaining context size. Furthermore, the system 102A may merge the sub-prompt 1 and the sub-prompt 2.

Additionally, the final set of merged sub-prompts may include the sub-prompt 1. Further, the sub-prompt 1 may summarize purpose and functionality of the provided COBOL program. Furthermore, the sub-prompt 1 may describe the main logic including input handling, validation, and output generation. Furthermore, the system 102A may describe the Copybook structure and its purpose and explain how it is used in the COBOL program. Furthermore, the sub-prompt 2 may analyze how the Copybook output, and Cobol script are interconnected within the codebase. Furthermore, the sub-prompt 2 may describe their interactions. Furthermore, the sub-prompt 3 may provide suggestions for improving the modularity, maintainability, and performance of the codebase. Furthermore, the sub-prompt 3 may consider factors like reusable COPYBOOK structures, repeated code to be used as paragraph. Furthermore, dependency of the sub-prompt 3 may depend on outputs from the sub-prompt 1 and the sub-prompt 2. Furthermore, the light weight lang model may be greater than equal to seq-seq a Recurrent Neural Network (RNN) models may be trained. Furthermore, the RNN may be a type of neural network architecture designed for processing sequential data, where the output at each step depends on previous computations.

FIG. 4A illustrates an example schematic diagram representation depicting an LLM-based agentic system 400A for optimizing prompts in a generative Artificial-Intelligence (AI) model, according to an example. Further, the LLM-based agentic system 400A may include a memory 402A, a role 404A, a plurality of tools 406A and a brain 408A. Furthermore, the brain 408A may provide that when the prompt 202 and the input 112A may be fed into the LLM 112B then an expected response 210 may be provided. FIG. 4B illustrates an example flow diagram representation depicting a Large Language Model (LLM) powered application 400B for optimizing prompts in a generative Artificial-Intelligence (AI) model, according to an example. Further, when the prompt 202 and the input 112A may be fed into the LLM 112B then an expected response 210 may be provided.

$$S = \{ \begin{matrix}1 , & if ( Traw\_input + Tprompt + Toutput ) \leq Cmodel \\ 0 , & if ( Traw\_input + Tprompt + Toutput ) > Cmodel\end{matrix} \qquad Equation 1$$

Where:
S: Response Success of the model (1=Success, 0=Failure).
Traw_input: Number of tokens in the raw input data.
Tprompt: Number of tokens in the prompt text.
Toutput: Estimated number of tokens in the output response.
Cmodel: Total context size or maximum token limit of the model.

Further, the maximum allowable tokens for the output can now be expressed as:

$$T \frac{max}{output} = Cmodel - ( Traw\_input + Tprompt ) \qquad Equation 2$$

Further, the condition for success may include the combined token count of the raw input, prompt, and output may not exceed context size of the model (C_{model}). Furthermore, the condition for failure may include when the sum exceeds (C_{model}), then the response generation may fail.

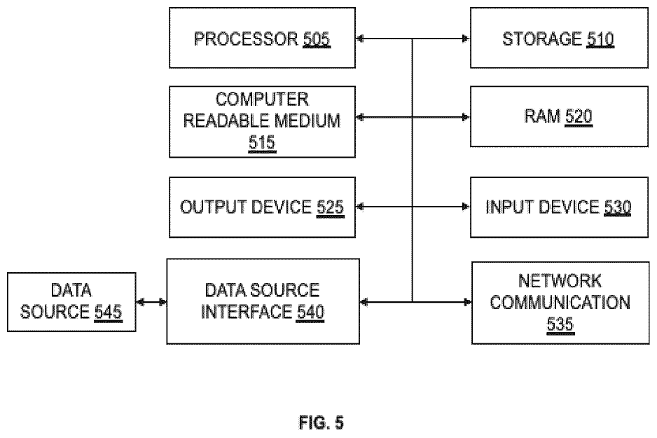

FIG. 5 illustrates an example block diagram 500 representation of a hardware platform for implementation of the disclosed system, according to an example. For the sake of brevity, the construction, and operational features of the system 102A which are explained in detail above are not explained in detail herein. Particularly, computing machines such as but not limited to internal/external server clusters, quantum computers, desktops, laptops, smartphones, tablets, and wearables may be used to execute the system 102A or may include the structure of the hardware platform 500. As illustrated, the hardware platform 500 may include additional components not shown, and some of the components described may be removed and/or modified. For example, a computer system with multiple GPUs may be located on external-cloud platforms, internal corporate cloud computing clusters, or organizational computing resources.

The hardware platform 500 may be a computer system such as the system 102A that may be used with the embodiments described herein. The computer system may represent a computational platform that includes components that may be in a server or another computer system. The computer system may be executed by the processor 505 (for example, single, or multiple processors) or other hardware processing circuits, the methods, functions, and other processes described herein. These methods, functions, and other processes may be embodied as machine-readable instructions stored on a computer-readable medium, which may be non-transitory, such as hardware storage devices (for example, random access memory (RAM), read-only memory (ROM), erasable, programmable ROM (EPROM), electrically erasable, programmable ROM (EEPROM), hard drives, and flash memory). Further, the computer system may include a storage 510. The computer system may include the processor 505 that executes software instructions or code stored on a non-transitory computer-readable storage medium 515 to perform methods of the present disclosure. The software code includes, for example, instructions to gather data and analyze the data. For example, the plurality of modules 108A may include but not limited to the sub-prompt generator 102B, the plurality of response token generator 104B, the merged sub-prompt generator 108B, the merged response generator 110B, and the Large Language Model (LLM) response generator 112B.

The instructions on the computer-readable storage medium 515 are read and stored the instructions in storage 515 or random-access memory (RAM). The computer-readable storage medium 515 may provide a space for keeping static data where at least some instructions could be stored for later execution. The stored instructions may be further compiled to generate other representations of the instructions and dynamically stored in the RAM such as RAM 520. The processor 505 may read instructions from the RAM 520 and perform actions as instructed.

The computer system may further include the output device 525 to provide at least some of the results of the execution as output including, but not limited to, visual information to users, such as external agents. The output device 525 may include a display on computing devices and virtual reality glasses. For example, the display may be a mobile phone screen or a laptop screen. GUIs and/or text may be presented as an output on the display screen. The computer system may further include an input device 530 to provide a user or another device with mechanisms for entering data and/or otherwise interacting with the computer system. The input device 530 may include, for example, a keyboard, a keypad, a mouse, or a touchscreen. Each of these output devices 525 and input device 530 may be joined by one or more additional peripherals. For example, the output device 525 may be used to display the results such as bot responses by the executable chatbot.

A network communicator 535 may be provided to connect the computer system to a network and in turn to other devices connected to the network including other clients, servers, data stores, and interfaces, for example. A network communicator 535 may include, for example, a network adapter such as a LAN adapter or a wireless adapter. The computer system may include a data sources interface 540 to access a data source interface 545. The data source interface 545 may be an information resource. As an example, a database of exceptions and rules may be provided as the data source interface 545. Moreover, knowledge repositories and curated data may be other examples of the data source interface 545.

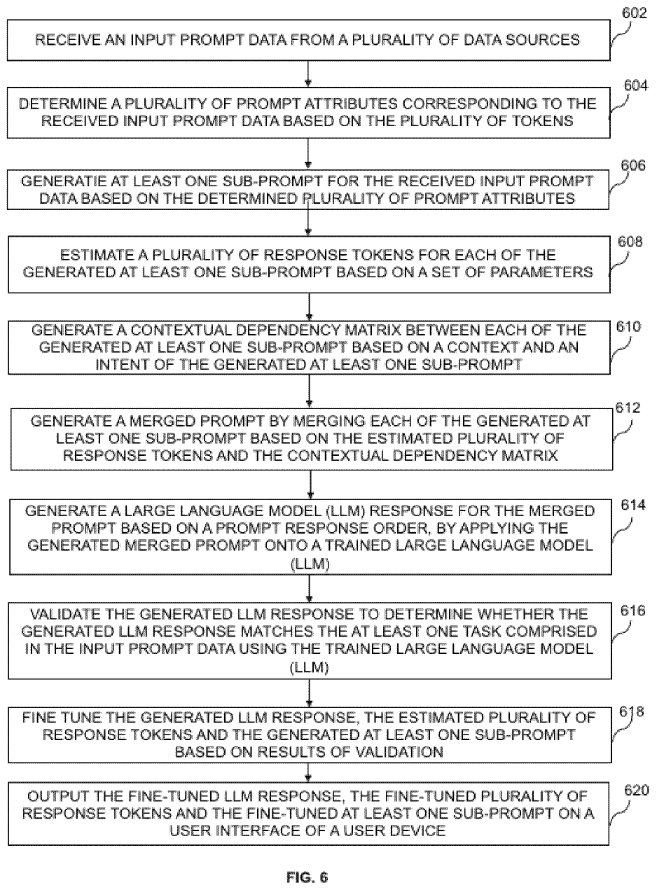

FIG. 6 illustrates an example flow chart depicting an example method for optimizing prompts in a generative Artificial-Intelligence (AI) model, according to an example.

At block 602, the method 600 may include receiving, by a processor 104A, an input prompt data 112A from a plurality of data sources 110A. Further, the input prompt data 112A comprises at least one task and a plurality of tokens associated with the at least one task.

At block 604, the method 600 may include determining, by the processor 104A, a plurality of prompt attributes corresponding to the received input prompt data 112A based on the plurality of tokens.

At block 606, the method 600 may include generating, by the processor 104A, at least one sub-prompt for the received input prompt data 112A based on the determined plurality of prompt attributes.

At block 608, the method 600 may include estimating, by the processor 104A, a plurality of response tokens for each of the generated at least one sub-prompt based on a set of parameters. Further, the plurality of response tokens may correspond to the plurality of tokens comprised in the input prompt data 112A.

At block 610, the method 600 may include generating, by the processor 104A, a contextual dependency matrix between each of the generated at least one sub-prompt based on a context and an intent of the generated at least one sub-prompt.

At block 612, the method 600 may include generating, by the processor 104A, a merged prompt by merging each of the generated at least one sub-prompt based on the estimated plurality of response tokens and the contextual dependency matrix.

At block 614, the method 600 may include generating, by the processor 104A, a Large Language Model (LLM) response for the merged prompt based on a prompt response order, by applying the generated merged prompt onto a trained Large Language Model (LLM).

At block 616, the method 600 may include validating, by the processor 104A, the generated LLM response to determine whether the generated LLM response matches the at least one task comprised in the input prompt data using the trained Large Language Model (LLM).

At block 618, the method 600 may include fine tuning, by the processor 104A, the generated LLM response, the estimated plurality of response tokens and the generated at least one sub-prompt based on results of validation.

At block 620, the method 600 may include outputting, by the processor 104A, the fine-tuned LLM response, the fine-tuned plurality of response tokens and the fine-tuned at least one sub-prompt on a user interface 120A of a user device 118A.

In an example, the method 600 may include the plurality of prompt attributes. Further, the plurality of prompt attributes may include a context, an intent, a topic modelling, a task type, complexity, dependencies, and sentence segments. Furthermore, the set of parameters may include a Large Language Model (LLM), a tokenizer process, a temperature setting, a prompt embedding, an input embedding, a number of prompts and input tokens.

In an example, the method 600 may include, generating, by the processor 104A, the at least one sub-prompt for the received input prompt data 112A based on the determined plurality of prompt attributes. Further, the method 600 may include segmenting, by the processor 104A, the received input prompt data 112A into a plurality of segments based on a syntactic structure, a semantic meaning, and a topic relevance of the received input prompt data using sentence segmentation model. Furthermore, the method 600 may include grouping, by the processor 104A, the plurality of segments into thematic clusters by detecting similarities in a content, a structure, and the topic between the plurality of segments. Furthermore, the method 600 may include determining, by the processor 104A, a plurality of relationships between the plurality of segments by analyzing dependencies within the received input prompt data. Furthermore, the dependencies may indicate cases where a response to one sub-prompt depends on a response to another sub-prompt. Furthermore, the method 600 may include generating, by the processor 104A, the at least one sub-prompt for the received input prompt data 112A based on the determined plurality of relationships.

In an example, the method 600 may include adjusting, by the processor 104A, the at least one sub-prompt based on at least one of feedback received from the trained Large Language Model (LLM), the dependencies, and the context. Further, the method 600 may include validating, by the processor 104A, the at least one sub-prompt for completeness, structural consistency, and alignment with the received input prompt data 112A. Furthermore, the method 600 may refining, by the processor 104A, the at least one sub-prompt by performing at least one of restructuring, merging, and splitting the sub-prompt based on results of validation.

In an example, the method 600 may include estimating, by the processor 104A, the plurality of response tokens for each of the generated at least one sub-prompt based on the set of parameters. Further, the method 600 may include receiving, by the processor 104A, a prompt, and an input as textual data to be processed from the plurality of data sources 110A. Furthermore, the prompt and the input may correspond to the received input prompt data. Furthermore, the method 600 may include generating, by the processor 104A, a tokenized prompt, and a tokenized input by tokenizing the received prompt and the input using a tokenizer model. Furthermore, a tokenizer model may include a predefined vocabulary and model-specific tokenization rules. Furthermore, the method 600 may include determining, by the processor 104A, a number of prompt tokens and input tokens from the tokenized prompt and the tokenized input. Furthermore, the method 600 may include generating, by the processor 104A, a plurality of embeddings for the prompt and the input based on the determined number of prompt tokens and the input tokens. Furthermore, the plurality of embeddings may include a prompt embedding and an input embedding. Furthermore, the method 600 may include extracting, by the processor 104A, a set of model-specific parameters from the trained LLM model. Furthermore, the set of model-specific parameters may include a type of the LLM, a tokenization method, a temperature setting, and a response generation behavior. Furthermore, the method 600 may include estimating, by the processor 104A, the plurality of response tokens for each of the generated at least one sub-prompt by applying the extracted set of model-specific parameters, the plurality of embeddings, the determined number of prompt tokens and the input tokens as input to an estimator function model.

In an example, the method 600 may include generating, by the processor 104A, the plurality of embeddings for the prompt and the input based on the determined number of prompt tokens and the input tokens. Further, the method 600 may include encoding, by the processor 104A, a plurality of features associated with the prompt and the input based on the tokenized prompt and the tokenized input. Furthermore, the plurality of features may include an average word length, a number of specific words, and a syntactic complexity. Furthermore, the method 600 may include generating, by the processor 104A, the prompt embedding and the input embedding based on the encoded plurality of features.

In an example, the method 600 may include generating, by the processor 104A, the merged prompt by merging each of the generated at least one sub-prompt based on the estimated plurality of response tokens and the contextual dependency matrix. Further, the method 600 may include estimating, by the processor 104A, a plurality of response token lengths corresponding to each of the sub-prompts using a response token estimator model, and the contextual dependency matrix. Furthermore, the method 600 may include determining, by the processor 104A, a merging strategy for the sub-prompts based on a shared context across the sub-prompts, an overlapping content within the sub-prompts, and dependency relationships indicated in the contextual dependency matrix. Furthermore, the method 600 may include identifying, by the processor 104A, at least one dependent sub-prompt where a response to the at least one dependent sub-prompt depends on a response to another sub-prompt. Furthermore, the method 600 may include predicting, by the processor 104A, a total plurality of response tokens required for merging the at least one dependent sub prompt. Furthermore, the method 600 may include determining, by the processor 104A, whether the predicted total plurality of response tokens exceeds a context window value. Furthermore, the method 600 may include assigning, by the processor 104A, a preference score to the at least one dependent sub prompt based on a dependency order. Furthermore, the preference score determines a sequence in which at least one dependent sub-prompt is to be merged and processed. Furthermore, the method 600 may include merging, by the processor 104A, the at least one dependent sub-prompt based on the merging strategy and until the predicted total plurality of response tokens reach the context window value.

In an example, the method 600 may include generating, by the processor 104A, the Large Language Model (LLM) response for the merged prompt based on the prompt response order. Further, the method 600 may include generating, by the processor 104A, a plurality of partial responses for each of the generated at least one sub-prompt. Furthermore, the method 600 may include processing, by the processor 104A, each of the generated plurality of partial responses using a preprocessing model. Furthermore, the method 600 may include determining, by the processor 104A, the prompt response order for generating a final Large Language Model (LLM) response. Furthermore, the method 600 may include generating, by the processor 104A, the final Large Language Model (LLM) response based on the determined prompt response order.

In an example, the method 600 may include validating, by the processor 104A, the generated LLM response to determine whether the generated LLM response matches the at least one task comprised in the input prompt data using the trained Large Language Model (LLM). Further, the method 600 may include extracting, by the processor 104A, task-related attributes from the input prompt data, wherein the task-related attributes comprise one a task type, an expected output structure, required information components, and dependencies between a plurality of response components. Furthermore, the method 600 may include generating, by the processor 104A, response embeddings by tokenizing the generated LLM response and encoding the LLM response into an embedding representation using the trained Large Language Model (LLM). Furthermore, the method 600 may include comparing, by the processor 104A, the generated response embeddings with expected response embeddings, wherein the expected response embeddings are derived from predefined task-specific reference embeddings, task type classification models, and historical prompt-response pairs. Furthermore, the method 600 may include determining, by the processor 104A, a response completeness value by determining whether the required information components from the input prompt data are present in the generated LLM response. Furthermore, the method 600 may include detecting, by the processor 104A, at least one inconsistency in the generated LLM response by identifying deviations within the generated LLM response, comparing the generated LLM response with pre-stored responses retrieved from external sources, and a response coherence level. Furthermore, the method 600 may include evaluating, by the processor 104A, an accuracy level of dependencies within the generated LLM response by verifying whether referenced sub-responses align with prior context of the merged sub-prompt. Furthermore, the method 600 may include generating, by the processor 104A, a validation score for the generated LLM response based on the determined response completeness value, detected at least one inconsistency, the response coherence level, and the accuracy level of dependencies.

In an example, the generated response embeddings are compared with expected response embeddings, the expected response embeddings are derived from predefined task-specific reference embeddings, task type classification models, and historical prompt-response pairs. Further, the response completeness is determined by checking whether all required information components from the input prompt are present in the generated response. Furthermore, inconsistencies in the generated response are detected by identifying contradictions within the generated response, comparing generated response details with known facts retrieved from external sources, and ensuring coherence across multiple sections of the generated response. Further, the correctness of dependencies within the generated response are evaluated by verifying whether referenced sub-responses correctly align with prior context provided in merged sub-prompts.

In an example, a validation score may refer to a numerical or categorical value representing the outcome of an automated evaluation process that measures how well the generated response satisfies one or more predefined criteria such as task completeness, logical consistency, dependency alignment, and format adherence. For example, a response that answers all parts of a prompt, maintains consistent flow, and correctly uses dependencies may receive a validation score of 0.92 on a scale from 0 to 1.

In an example, a contextual dependency matrix may refer to a structured representation (for example, a 2D array or graph) indicating relationships between sub-prompts or segments, where each entry denotes whether and how one sub-prompt depends on another for generating a coherent or complete response.

In an example, the plurality of response tokens may refer to multiple predicted or generated tokens corresponding to one or more LLM responses, where each sub-prompt may yield a distinct number of tokens. The term “plurality” indicates that the system accounts for more than one such token count or sequence.

In an example, a merging strategy may refer to as a defined procedural approach used to determine how sub-prompts are grouped or combined into merged prompts. The merging strategy considers factors such as shared context, overlapping content, response token estimates, and dependency relationships. For example, the system applies a greedy merging strategy where it starts combining sub-prompts with the least combined estimated token usage until the context window limit is reached. For example, a merging strategy might prioritize concatenating sub-prompts based on their semantic similarity, ensuring that related topics (for example, questions about financial data) are grouped together to maintain contextual continuity. Alternatively, it could involve interleaving sub-prompts to balance token distribution, preventing overflow in scenarios where a single sub-prompt is token heavy.

In an example, a context window value may refer to the maximum number of tokens (input, prompt, response) that a given LLM may process in a single inference call. For example, for GPT-4, the context window value could be 8192 tokens or 32,768 tokens, depending on the version.

In an example, a preference score may refer to a weighted numerical value assigned to sub-prompts or tasks that indicates their priority for response generation or merging, particularly when dependencies exist between sub-prompts. For example, if sub-prompt A must be answered before B, then A is assigned a preference score of 1.0, B a score of 0.8, and C a score of 0.5, dictating processing order. The preference score is a quantitative or qualitative metric assigned to sub-prompts or prompt components to evaluate their relative importance, relevance, or suitability for processing within a given context. This score guides the prioritization and sequencing of sub-prompts during the merging and processing phases. Specifically, the preference score determines the sequence in which at least one dependent sub-prompt is to be merged and processed, ensuring that higher-priority or contextually critical sub-prompts are addressed first. For instance, in a multi-turn dialogue system, a sub-prompt requesting clarification of a user's query might receive a higher preference score (for example, 0.9 on a 0-1 scale) than a follow-up sub-prompt summarizing the conversation (for example, 0.6), resulting in the clarification sub-prompt being merged and processed first to maintain dialogue coherence.

The dependency order refers to the hierarchical or sequential arrangement of sub-prompts or prompt components based on their interdependencies, dictating the order in which they must be processed to ensure logical and accurate outcomes. This order accounts for relationships where the processing of one sub-prompt relies on the output or context of another. For example, in a task involving step-by-step reasoning, the dependency order might require a sub-prompt that defines key variables (for example, “Calculate the total revenue”) to be processed before a dependent sub-prompt that uses those variables (for example, “Determine the profit margin”). By enforcing this order, the system ensures that the LLM generates responses that are contextually consistent and computationally valid.

In an example, a response coherence level may refer to a metric that quantifies how logically, structurally, and semantically connected the components of a generated response are. This score may be based on intra-response flow, transitions between sections, or the absence of contradictory statements. For example, a summary that jumps erratically between unrelated topics may have a response coherence level of 0.3 on a 0-1 scale.

In an example, an accuracy level may refer to a measure of how precisely the content in the generated response reflects the required facts, structure, and dependencies as defined in the input prompt or verified by reference data. For example, if 9 out of 10 required facts in a response are correct, the accuracy level may be reported as 90%.

In an example, response token lengths may refer to the actual or estimated number of tokens produced by the LLM in response to a given sub-prompt or merged prompt. This length is used to ensure that token usage stays within model limits. For example, a response to “Summarize the article” generates 110 tokens; this is the response token length for that task.

The method 600 may be implemented in any suitable hardware, software, firmware, or combination thereof. The order in which the method 600 is described is not intended to be construed as a limitation, and any number of the described method blocks may be combined or otherwise performed in any order to implement the method 600 or an alternate method. Additionally, individual blocks may be deleted from the method 600 without departing from the spirit and scope of the present disclosure described herein.

Furthermore, the method 600 may be implemented in any suitable hardware, software, firmware, or a combination thereof, that exists in the related art or that is later developed. The method 600 describes, without limitation, the implementation of the system 102A. A person of skill in the art will understand that method 600 may be modified appropriately for implementation in various manners without departing from the scope and spirit of the disclosure.

In an example, a non-transitory computer readable medium is provided. Further, the non-transitory computer readable medium may include a processor executable instruction that cause a processor 104A to receive the input prompt data 112A from the plurality of data sources 110A. Furthermore, the input prompt data 112A may include at least one task and a plurality of tokens associated with the at least one task. Furthermore, the processor executable instruction that cause the processor 104A to determine a plurality of prompt attributes corresponding to the received input prompt data 112A based on the plurality of tokens. Furthermore, the processor executable instruction that may cause the processor 104A to generate at least one sub-prompt for the received input prompt data 112A based on the determined plurality of prompt attributes. Furthermore, the processor executable instruction that may cause the processor 104A to estimate a plurality of response tokens for each of the generated at least one sub-prompt based on a set of parameters. Furthermore, the plurality of response tokens may correspond to the plurality of tokens comprised in the input prompt data 112A. Furthermore, the processor executable instruction that may cause the processor 104A to generate a contextual dependency matrix between each of the generated at least one sub-prompt based on a context and an intent of the generated at least one sub-prompt. Furthermore, the processor executable instruction that may cause the processor 104A to generate a merged prompt by merging each of the generated at least one sub-prompt based on the estimated plurality of response tokens and the contextual dependency matrix. Furthermore, the processor executable instruction that may cause the processor 104A to generate a Large Language Model (LLM) response for the merged prompt based on a prompt response order, by applying the generated merged prompt onto a trained Large Language Model (LLM). Furthermore, the processor executable instruction that may cause the processor 104A to validate the generated LLM response to determine whether the generated LLM response matches the at least one task comprised in the input prompt data 112A using the trained Large Language Model (LLM). Furthermore, the processor executable instruction that may cause the processor 104A to fine tune the generated LLM response, the estimated plurality of response tokens and the generated at least one sub-prompt based on results of validation. Furthermore, the processor executable instruction that may cause the processor 104A to output 116A the fine-tuned LLM response, the fine-tuned plurality of response tokens and the fine-tuned at least one sub-prompt on the user interface 120A of the user device 118A.

In an example, the processor-executable instructions may cause the processor to adjust the at least one sub-prompt based on at least one of feedback received from the trained Large Language Model (LLM), the dependencies, and the context. Further, the processor-executable instructions may cause the processor 104A to validate the at least one sub-prompt for completeness, structural consistency, and alignment with the received input prompt data 112A. Furthermore, the processor-executable instructions may cause the processor 104A to refine the at least one sub-prompt by performing at least one of restructuring, merging, and splitting the sub-prompt based on results of validation.

The present disclosure provides a system and method for optimizing prompts in a generative Artificial-Intelligence (AI) model. The present system may dynamically refine prompts based on raw input. Further, the present system may estimate output token requirements. Furthermore, the present system may adapt prompts to ensure outputs remain coherent and relevant. Furthermore, the system may minimize token overflow failures, which may enhance LLM reliability.

Additionally, the present system may strengthen the LLM-based agents, which may make the LLM-based agents more robust and versatile. Further, the LLM-based agents may manage workflows, interact with tools, and handle dynamic queries. Further, the present system may maintain functionality and deliver consistent outputs. Furthermore, ensures LLM-based agents excel in real-world, mission-critical scenarios by systematical addressing of the token constraints.

The present systems and methods may optimize prompts at runtime for mitigating LLM and LLM based Agent failures due to context window overflow issues. Further, the method may estimate response tokens based on but not limited to input, prompt, LLM and tokenizer. Further, the method may acquire prompt and input embeddings specifically for the token estimation task. Furthermore, the method of estimating response tokens may help in identification whether the LLM may fail to generate response due to insufficient context length. Furthermore, the method may then help alleviate such issue by finetuning the initial prompt into multiple sub-prompts. Furthermore, the present method may dynamically split and finetune the prompt into multiple sub-prompts based on prompt attributes/aspects such that responses for each of the sub-prompt may fit into context window and thereafter combine the generated sub-prompt responses into the final cohesive response.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, and the like. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, and the like, of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based here on. Accordingly, the embodiments of the present invention are intended to be illustrative, but not limited, of the scope of the invention, which is outlined in the following claims.

1. A system comprising:
a processor; and
a memory communicably coupled to the processor, wherein the memory comprises processor-executable instructions which, when executed by the processor, cause the processor to:
receive an input prompt data from a plurality of data sources, wherein the input prompt data comprises at least one task and a plurality of tokens associated with the at least one task;
determine a plurality of prompt attributes corresponding to the received input prompt data based on the plurality of tokens;
generate at least one sub-prompt for the received input prompt data based on the determined plurality of prompt attributes;
estimate a plurality of response tokens for each of the generated at least one sub-prompt based on a set of parameters, wherein the plurality of response tokens correspond to the plurality of tokens comprised in the input prompt data;
generate a contextual dependency matrix between each of the generated at least one sub-prompt based on a context and an intent of the generated at least one sub-prompt;
generate a merged prompt by merging each of the generated at least one sub-prompt based on the estimated plurality of response tokens and the contextual dependency matrix;
generate a Large Language Model (LLM) response for the merged prompt based on a prompt response order, by applying the generated merged prompt onto a trained Large Language Model (LLM);
validate the generated LLM response to determine whether the generated LLM response matches the at least one task comprised in the input prompt data using the trained Large Language Model (LLM);
fine tune the generated LLM response, the estimated plurality of response tokens and the generated at least one sub-prompt based on results of validation; and
output the fine-tuned LLM response, the fine-tuned plurality of response tokens and the fine-tuned at least one sub-prompt on a user interface of a user device.

2. The system of claim 1, wherein the plurality of prompt attributes comprise a context, an intent, a topic modelling, a task type, complexity, dependencies, and sentence segments and wherein the set of parameters comprise a Large Language Model (LLM), a tokenizer process, a temperature setting, a prompt embedding, an input embedding, a number of prompts and input tokens.

3. The system of claim 1, wherein to generate the at least one sub-prompt for the received input prompt data based on the determined plurality of prompt attributes, the processor is to:
segment the received input prompt data into a plurality of segments based on a syntactic structure, a semantic meaning, and a topic relevance of the received input prompt data using sentence segmentation model;
group the plurality of segments into thematic clusters by detecting similarities in a content, a structure, and the topic between the plurality of segments;
determine a plurality of relationships between the plurality of segments by analyzing dependencies within the received input prompt data, wherein the dependencies indicate cases where a response to one sub-prompt depends on a response to another sub-prompt; and
generate the at least one sub-prompt for the received input prompt data based on the determined plurality of relationships.

4. The system of claim 3, wherein the processor is further to:
adjust the at least one sub-prompt based on at least one of feedback received from the trained Large Language Model (LLM), the dependencies, and the context;
validate the at least one sub-prompt for completeness, structural consistency, and alignment with the received input prompt data; and
refine the at least one sub-prompt by performing at least one of restructuring, merging, and splitting the sub-prompt based on results of validation.

5. The system of claim 1, wherein to estimate the plurality of response tokens for each of the generated at least one sub-prompt based on the set of parameters, the processor is to:
receive a prompt and an input as textual data to be processed from the plurality of data sources, wherein the prompt and the input corresponds to the received input prompt data;
generate a tokenized prompt and a tokenized input by tokenizing the received prompt and the input using a tokenizer model, wherein tokenizer model comprises a predefined vocabulary and model-specific tokenization rules;
determine a number of prompt tokens and input tokens from the tokenized prompt and the tokenized input;
generate a plurality of embeddings for the prompt and the input based on the determined number of prompt tokens and the input tokens, wherein the plurality of embeddings comprise a prompt embedding and an input embedding;
extract a set of model-specific parameters from the trained LLM model, wherein the set of model-specific parameters comprise a type of the LLM, a tokenization method, a temperature setting, and a response generation behavior; and
estimate the plurality of response tokens for each of the generated at least one sub-prompt by applying the extracted set of model-specific parameters, the plurality of embeddings, the determined number of prompt tokens and the input tokens as input to an estimator function model.

6. The system of claim 5, wherein to generate the plurality of embeddings for the prompt and the input based on the determined number of prompt tokens and the input tokens, the processor is to:
encode a plurality of features associated with the prompt and the input based on the tokenized prompt and the tokenized input, wherein the plurality of features comprise an average word length, a number of specific words, and a syntactic complexity; and
generate the prompt embedding and the input embedding based on the encoded plurality of features.

7. The system of claim 1, wherein to generate the merged prompt by merging each of the generated at least one sub-prompt based on the estimated plurality of response tokens and the contextual dependency matrix, the processor is to:
estimate a plurality of response token lengths corresponding to each of the sub-prompts using a response token estimator model, and the contextual dependency matrix;
determine a merging strategy for the sub-prompts based on a shared context across the sub-prompts, an overlapping content within the sub-prompts, and dependency relationships indicated in the contextual dependency matrix;
identify at least one dependent sub-prompt where a response to the at least one dependent sub-prompt depends on a response to another sub-prompt;
predict a total plurality of response tokens required for merging the at least one dependent sub prompt;
determine whether the predicted total plurality of response tokens exceeds a context window value;
assign a preference score to the at least one dependent sub prompt based on a dependency order, wherein the preference score determines a sequence in which the at least one dependent sub-prompt is to be merged and processed; and
merge the at least one dependent sub-prompt based on the merging strategy and until the predicted total plurality of response tokens reach the context window value.

8. The system of claim 1, wherein to generate the Large Language Model (LLM) response for the merged prompt based on the prompt response order, the processor is further to:
generate a plurality of partial responses for each of the generated at least one sub-prompt;
process each of the generated plurality of partial responses using a preprocessing model;
determine the prompt response order for generating a final Large Language Model (LLM) response; and
generate the final Large Language Model (LLM) response based on the determined prompt response order.

9. The system of claim 1, wherein to validate the generated LLM response to determine whether the generated LLM response matches the at least one task comprised in the input prompt data using the trained Large Language Model (LLM), the processor is to:
extract task-related attributes from the input prompt data, wherein the task-related attributes comprise one a task type, an expected output structure, required information components, and dependencies between a plurality of response components;
generate response embeddings by tokenizing the generated LLM response and encoding the LLM response into an embedding representation using the trained Large Language Model (LLM);
compare the generated response embeddings with expected response embeddings, wherein the expected response embeddings are derived from predefined task-specific reference embeddings, task type classification models, and historical prompt-response pairs;
determine a response completeness value by determining whether the required information components from the input prompt data are present in the generated LLM response;
detect at least one inconsistency in the generated LLM response by identifying deviations within the generated LLM response, comparing the generated LLM response with pre-stored responses retrieved from external sources, and
a response coherence level;
evaluate an accuracy level of dependencies within the generated LLM response by verifying whether referenced sub-responses align with prior context of the merged sub-prompt; and
generate a validation score for the generated LLM response based on the determined response completeness value, detected at least one inconsistency, the response coherence level, and the accuracy level of dependencies.

10. A method comprising:
receiving, by a processor, an input prompt data from a plurality of data sources, wherein the input prompt data comprises at least one task and a plurality of tokens associated with the at least one task;
determining, by the processor, a plurality of prompt attributes corresponding to the received input prompt data based on the plurality of tokens;
generating, by the processor, at least one sub-prompt for the received input prompt data based on the determined plurality of prompt attributes;
estimating, by the processor, a plurality of response tokens for each of the generated at least one sub-prompt based on a set of parameters, wherein the plurality of response tokens correspond to the plurality of tokens comprised in the input prompt data;
generating, by the processor, a contextual dependency matrix between each of the generated at least one sub-prompt based on a context and an intent of the generated at least one sub-prompt;
generating, by the processor, a merged prompt by merging each of the generated at least one sub-prompt based on the estimated plurality of response tokens and the contextual dependency matrix;
generating, by the processor, a Large Language Model (LLM) response for the merged prompt based on a prompt response order, by applying the generated merged prompt onto a trained Large Language Model (LLM);
validating, by the processor, the generated LLM response to determine whether the generated LLM response matches the at least one task comprised in the input prompt data using the trained Large Language Model (LLM);
fine tuning, by the processor, the generated LLM response, the estimated plurality of response tokens and the generated at least one sub-prompt based on results of validation; and
outputting, by the processor, the fine-tuned LLM response, the fine-tuned plurality of response tokens and the fine-tuned at least one sub-prompt on a user interface of a user device.

11. The method of claim 10, wherein the plurality of prompt attributes comprise a context, an intent, a topic modelling, a task type, complexity, dependencies, and sentence segments and wherein the set of parameters comprise a Large Language Model (LLM), a tokenizer process, a temperature setting, a prompt embedding, an input embedding, a number of prompts and input tokens.

12. The method of claim 10, wherein generating the at least one sub-prompt for the received input prompt data based on the determined plurality of prompt attributes comprises:
segmenting, by the processor, the received input prompt data into a plurality of segments based on a syntactic structure, a semantic meaning, and a topic relevance of the received input prompt data using sentence segmentation model;
grouping, by the processor, the plurality of segments into thematic clusters by detecting similarities in a content, a structure, and the topic between the plurality of segments;
determining, by the processor, a plurality of relationships between the plurality of segments by analyzing dependencies within the received input prompt data, wherein the dependencies indicate cases where a response to one sub-prompt depends on a response to another sub-prompt; and
generating, by the processor, the at least one sub-prompt for the received input prompt data based on the determined plurality of relationships.

13. The method of claim 12, further comprising:
adjusting, by the processor, the at least one sub-prompt based on at least one of feedback received from the trained Large Language Model (LLM), the dependencies, and the context;
validating, by the processor, the at least one sub-prompt for completeness, structural consistency, and alignment with the received input prompt data; and
refining, by the processor, the at least one sub-prompt by performing at least one of restructuring, merging, and splitting the sub-prompt based on results of validation.

14. The method of claim 10, wherein estimating the plurality of response tokens for each of the generated at least one sub-prompt based on the set of parameters comprises:
receiving, by the processor, a prompt, and an input as textual data to be processed from the plurality of data sources, wherein the prompt and the input corresponds to the received input prompt data;
generating, by the processor, a tokenized prompt, and a tokenized input by tokenizing the received prompt and the input using a tokenizer model, wherein tokenizer model comprises a predefined vocabulary and model-specific tokenization rules;
determining, by the processor, a number of prompt tokens and input tokens from the tokenized prompt and the tokenized input;
generating, by the processor, a plurality of embeddings for the prompt and the input based on the determined number of prompt tokens and the input tokens, wherein the plurality of embeddings comprise a prompt embedding and an input embedding;
extracting, by the processor, a set of model-specific parameters from the trained LLM model, wherein the set of model-specific parameters comprise a type of the LLM, a tokenization method, a temperature setting, and a response generation behavior; and
estimating, by the processor, the plurality of response tokens for each of the generated at least one sub-prompt by applying the extracted set of model-specific parameters, the plurality of embeddings, the determined number of prompt tokens and the input tokens as input to an estimator function model.

15. The method of claim 14, wherein generating the plurality of embeddings for the prompt and the input based on the determined number of prompt tokens and the input tokens comprises:
encoding, by the processor, a plurality of features associated with the prompt and the input based on the tokenized prompt and the tokenized input, wherein the plurality of features comprise an average word length, a number of specific words, and a syntactic complexity; and
generating, by the processor, the prompt embedding and the input embedding based on the encoded plurality of features.

16. The method of claim 10, wherein generating the merged prompt by merging each of the generated at least one sub-prompt based on the estimated plurality of response tokens and the contextual dependency matrix comprises:
estimating, by the processor, a plurality of response token lengths corresponding to each of the sub-prompts using a response token estimator model, and the contextual dependency matrix;
determining, by the processor, a merging strategy for the sub-prompts based on a shared context across the sub-prompts, an overlapping content within the sub-prompts, and dependency relationships indicated in the contextual dependency matrix;
identifying, by the processor, at least one dependent sub-prompt where a response to the at least one dependent sub-prompt depends on a response to another sub-prompt;
predicting, by the processor, a total plurality of response tokens required for merging the at least one dependent sub prompt;
determining, by the processor, whether the predicted total plurality of response tokens exceeds a context window value;
assigning, by the processor, a preference score to the at least one dependent sub prompt based on a dependency order, wherein the preference score determines a sequence in which at least one dependent sub-prompt is to be merged and processed; and
merging, by the processor, the at least one dependent sub-prompt based on the merging strategy and until the predicted total plurality of response tokens reach the context window value.

17. The method of claim 10, wherein generating the Large Language Model (LLM) response for the merged prompt based on the prompt response order comprises:
generating, by the processor, a plurality of partial responses for each of the generated at least one sub-prompt;
processing, by the processor, each of the generated plurality of partial responses using a preprocessing model;
determining, by the processor, the prompt response order for generating a final Large Language Model (LLM) response; and
generating, by the processor, the final Large Language Model (LLM) response based on the determined prompt response order.

18. The method of claim 10, wherein validating the generated LLM response to determine whether the generated LLM response matches the at least one task comprised in the input prompt data using the trained Large Language Model (LLM) comprises:
extracting, by the processor, task-related attributes from the input prompt data, wherein the task-related attributes comprise one a task type, an expected output structure, required information components, and dependencies between a plurality of response components;
generating, by the processor, response embeddings by tokenizing the generated LLM response and encoding the LLM response into an embedding representation using the trained Large Language Model (LLM);
comparing, by the processor, the generated response embeddings with expected response embeddings, wherein the expected response embeddings are derived from predefined task-specific reference embeddings, task type classification models, and historical prompt-response pairs;
determining, by the processor, a response completeness value by determining whether the required information components from the input prompt data are present in the generated LLM response;
detecting, by the processor, at least one inconsistency in the generated LLM response by identifying deviations within the generated LLM response, comparing the generated LLM response with pre-stored responses retrieved from external sources, and a response coherence level;
evaluating, by the processor, an accuracy level of dependencies within the generated LLM response by verifying whether referenced sub-responses align with prior context of the merged sub-prompt; and
generating, by the processor, a validation score for the generated LLM response based on the determined response completeness value, detected at least one inconsistency, the response coherence level, and the accuracy level of dependencies.

19. A non-transitory computer readable medium comprising a processor executable instructions that cause a processor to:
receive an input prompt data from a plurality of data sources, wherein the input prompt data comprises at least one task and a plurality of tokens associated with the at least one task;
determine a plurality of prompt attributes corresponding to the received input prompt data based on the plurality of tokens;
generate at least one sub-prompt for the received input prompt data based on the determined plurality of prompt attributes;
estimate a plurality of response tokens for each of the generated at least one sub-prompt based on a set of parameters, wherein the plurality of response tokens correspond to the plurality of tokens comprised in the input prompt data;
generate a contextual dependency matrix between each of the generated at least one sub-prompt based on a context and an intent of the generated at least one sub-prompt;
generate a merged prompt by merging each of the generated at least one sub-prompt based on the estimated plurality of response tokens and the contextual dependency matrix;
generate a Large Language Model (LLM) response for the merged prompt based on a prompt response order, by applying the generated merged prompt onto a trained Large Language Model (LLM);
validate the generated LLM response to determine whether the generated LLM response matches the at least one task comprised in the input prompt data using the trained Large Language Model (LLM);
fine tune the generated LLM response, the estimated plurality of response tokens and the generated at least one sub-prompt based on results of validation; and
output the fine-tuned LLM response, the fine-tuned plurality of response tokens and the fine-tuned at least one sub-prompt on a user interface of a user device.

20. The non-transitory computer readable medium of claim 19, wherein, the processor-executable instructions cause the processor to:
adjust the at least one sub-prompt based on at least one of feedback received from the trained Large Language Model (LLM), the dependencies, and the context;
validate the at least one sub-prompt for completeness, structural consistency, and alignment with the received input prompt data; and
refine the at least one sub-prompt by performing at least one of restructuring, merging, and splitting the sub-prompt based on results of validation.
